(19) United States
(12) Patent Application Publication
(10) Pub. No.: US 2008/0074231 A1
(43) Pub. Date: Mar. 27, 2008

(54) Safety switch

(76) Inventor: Albert Huang, Taipei (TW)

Correspondence Address: COOPER & DUNHAM, LLP, 1185 AVENUE OF THE AMERICAS, NEW YORK, NY, 10036, US

(21) Appl. No.: 11/526,043

(22) Filed: Sep. 22, 2006

(51) Int. Cl. H01H 71/16

(52) U.S. Cl. 337/70

(57) ABSTRACT

A safety switch has a housing, multiple legs and a cover. The housing is hollow and has a space, an opening, multiple gaps, a bottom and a front. The space is defined in the housing. The opening is defined in the front. The gaps are respectively defined through the bottom. The legs are respectively mounted in the gaps and each has a vertical edge. The cover is mounted on the opening of the housing and has the inner surface. The inner surface tightly abuts and holds the vertical edge of the legs to hold securely the legs in the gaps. Therefore, the safety switch has a low cost and is compact.

### BACKGROUND OF THE INVENTION

1. Field of the Invention

The present invention relates to a switch, and especially to a safety switch that is compact and has a low cost.

2. Description of the Related Art

With reference to FIG. 4, a conventional safety switch comprises a housing (50), a cover and multiple legs (60). The housing (50) is hollow and comprises a front, a bottom, a space (51), an opening (52) and multiple gaps (53). The space (51) is defined in the housing (50) to contain elements for protecting the switch from overloading. The opening (52) is defined in the front. The gaps (53) are respectively defined in the bottom and each comprises a mounting tab and an inner surface. The mounting tab is formed on and protrudes out of the inner surface. The cover is mounted on the opening (52) of the housing (50) and comprises multiple mounting tabs and an inner surface. The mounting tabs are formed on and protrude out of the inner surface of the cover and respectively correspond to the mounting tabs of the gaps (53). With further reference to FIGS. 5A to 5C, the legs (60) are respectively mounted in the gaps (53) and each leg (60) comprise two opposite vertical edges, an upper portion, a protrusion (61) and two opposite gaps (62). The protrusion (61) is formed on and protrudes out of the vertical edges on the upper portion and comprises two opposite edges. The gaps (62) are respectively defined in the opposite edges of the protrusion (61) and respectively hold a corresponding mounting tab of the gaps (53) of the housing (50) and a corresponding mounting tab of the cover so the legs are held securely in the gaps (53) of the housing (50).

However, the protrusion (61) protrudes out of the vertical edges so that the amount of material for manufacturing the legs (60) increases. Furthermore, the volume of the housing (50) needs to be enlarged to contain the legs (60). Therefore, the safety switch is incompact and has a high cost for manufacturing.

### SUMMARY OF THE INVENTION

The objective of the present invention is to provide a safety switch that is compact and has a low cost.

To achieve the foregoing objective, a safety switch in accordance with the present invention has a housing, multiple legs and a cover. The housing is hollow and comprises a space, an opening, multiple gaps, a bottom and a front. The space is defined in the housing to contain elements for protecting the switch from overloading. The opening is defined in the front. The gaps are respectively defined through the bottom. Each leg is respectively mounted in one of the gaps and has a vertical edge. The cover is mounted on the opening of the housing and has the inner surface. The inner surface tightly abuts and holds the vertical edge of the legs to hold securely the legs in the gaps. Therefore, the safety switch has a low cost and is compact.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a safety switch in accordance with the present invention;

FIG. 2 is a perspective view of the safety switch in FIG. 1 without a cover;

FIG. 3 is a side view of the safety switch in FIG. 1;

FIG. 4 is a perspective view of a conventional safety switch without a cover;

FIG. 5A is a perspective view of one of the conventional legs in FIG. 3;

FIG. 5B is a perspective view of one of the conventional legs in FIG. 3; and

FIG. 5C is perspective view of one of the conventional legs in FIG. 3.

### DETAILED DESCRIPTION OF THE PREFERRED EMBODIMENTS

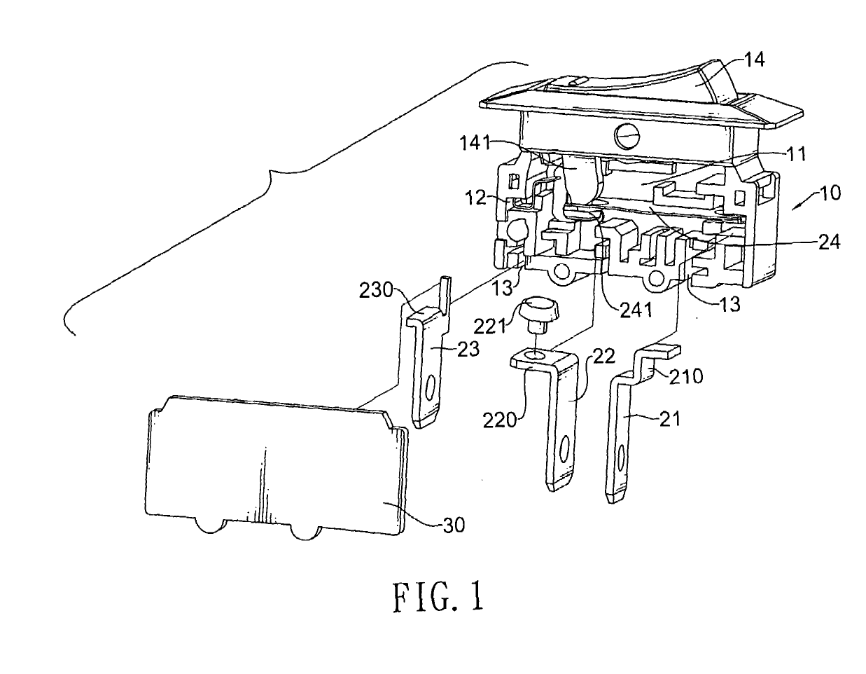

With reference to FIG. 1, a safety switch in accordance with the present invention is mounted on a power strip having a power-supplying circuit and may activate or cut off the power-supply circuit.

The safety switch comprises a housing (10), a first leg (21), a second leg (22), a third leg (23), a bimetal plate (24) and a cover (30).

The housing (10) is hollow and comprises a top, a front, a bottom, a space (11), an opening (12), multiple gaps (13) and a button (14). The space (11) is defined in the housing (10) to contain elements for protecting the switch from overloading. The opening (12) is defined in the front. The gaps (13) are respectively defined through the bottom. The button (14) is mounted on and protrudes up from the top of the housing (10) to activate or cut off power-supplying circuit and comprises an arm (141). The arm (141) extends form the button into the space (11).

The first leg (21) is mounted in one of the gaps (13) and comprises a top, a vertical edge and a contact (210). The top of the first leg (21) is bent and is mounted through the corresponding gap (13). The contact (210) is formed on the top of the first leg (21).

The second leg (22) is mounted in one of the gaps (13) and comprises a top, a vertical edge, a contact (220) and a point (221). The top of the second leg (22) is bent and corresponds to the corresponding gap (13). The contact (220) is formed on the top of the second leg (22). The point (221) is mounted on the contact (220).

The third leg (23) is mounted in one of the gaps (13) and comprises a top, a vertical edge and a contact (230). The top of the third leg (23) is bent and corresponds to the corresponding gap (13). The contact (230) is formed on the top and connected to the power-supplying circuit.

The bimetal plate (24) is mounted on the top of the first leg (21) and comprises a distal end, a point (241), a bottom and a top. The point (241) is mounted at the distal end on the bottom of the bimetal plate (24) and corresponds to and selectively contacts the point (221) of the second leg (22). The distal end contacts with the arm (141) of the button (14). When a use presses the button to turn on the power strip, the arm (141) of the button presses the bimetal plate (14) to conduct electricity between the point (241) of the bimetal plate (24) and the point (221) of the second leg (22) to activate the power-supplying circuit. When the current in the power-supplying circuit is too high, the temperature of the bimetal plate (24) increases excessively to make the bimetal plate (24) to separate from the point (221) of the second leg (22) and deactivate the power-supplying circuit due to a bimetallic characteristic of the bimetal plate (24).

The cover (30) is mounted on the opening (12) of the housing (10) and comprises an inner surface. The inner surface of the cover (30) tightly abuts and holds the vertical edge of the first leg (21), the vertical edge of the second leg (22) and the vertical edge of the third leg (23) to hold securely the first leg (21), the second leg (22) and the third leg (23) in the gaps (13).

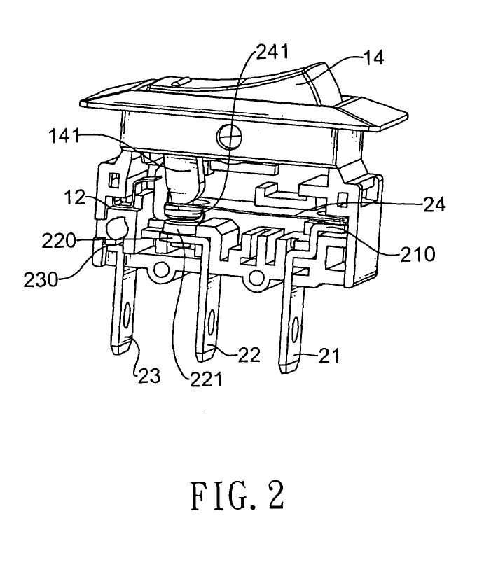

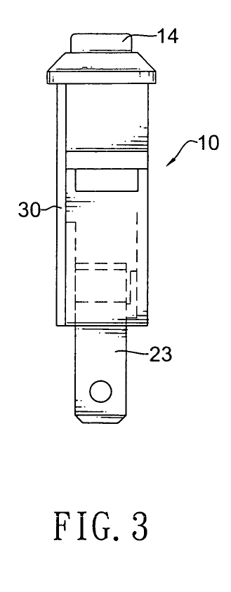

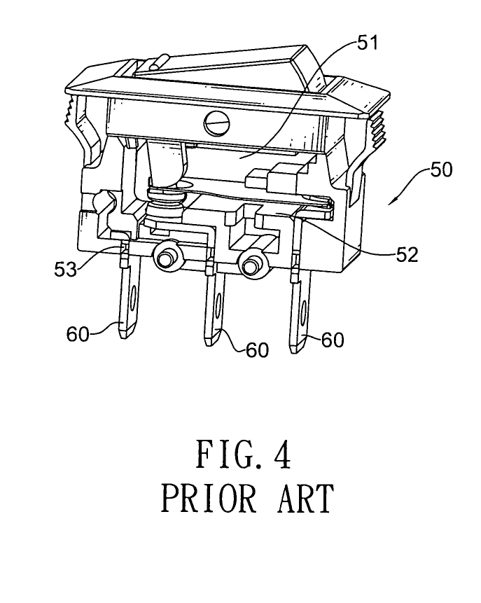

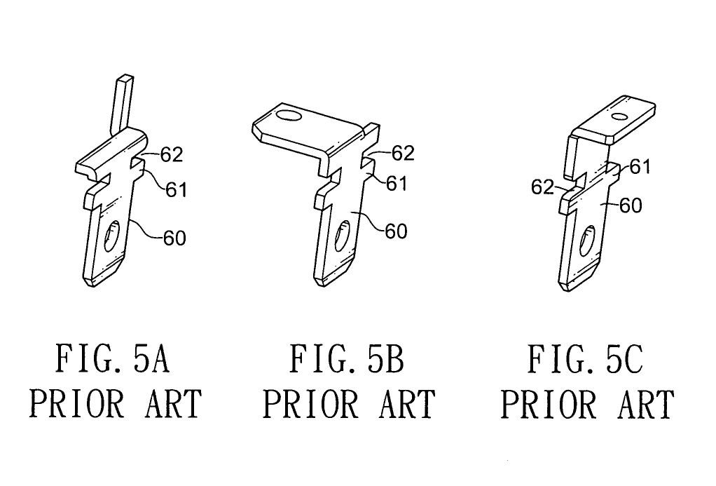

With reference to FIGS. 2 and 3, the cover (30) tightly abutting the vertical edges of the first leg (21) the second leg (22) and the third leg (23) prevent the first, second and third legs (21, 22, 23) from moving and makes the safety switch firm. When a user presses the button (14) to turn on the power strip, the arm (141) of the button pushes the bimetal plate (14) to contact the second leg (22) to activate the power-supplying circuit. When the current is too high, the bimetal plate (24) separate from the point (221) of the second leg (22) to break power-supplying circuit.

The volume of the safety switch is reduced due to the cover (30) directly attaching the vertical edges of the first leg (21), the second leg (22)and the third leg (23) without extra protrusions. Therefore, the safety switch has a low cost and is compact.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A safety switch comprising
a housing being hollow and having
a top;
a front;
a bottom
a space defined in the housing;
an opening defined in the front; and
multiple gaps defined in the bottom;
a first leg mounted in one of the gaps and having
a top being bent and mounted in a corresponding one of the gaps;
a vertical edge; and
a contact formed on the top of the first leg;
a second leg mounted in one of the gaps and having
a top being bent and mounted through a corresponding one of the gaps;
a vertical edge;
a contact formed on the top of the second leg; and
a point mounted on the contact on the second leg;
a third leg mounted in one of the gaps and having
a top being bent and mounted through a corresponding one of the gaps;
a vertical edge; and
a contact formed on the top of the third leg;
a bimetal plate mounted on the top of the first leg and having
a distal end;
a bottom;
a top; and
a point mounted at the distal end on the bottom of the bimetal plate and corresponding to and selectively contacting the point of the second leg; and
a cover mounted on the opening of the housing and having
an inner surface tightly abutting and holding the vertical edges of the first leg, the second leg and the third leg.

2. The safety switch as claimed in claim 1, wherein
the housing comprises a button mounted on and protruding up from the top of the housing and having
an arm extends form the button into the space; and
the distal end of the bimetal plate abuts with the arm of the button.
